(19) United States
(12) Patent Application Publication
(10) Pub. No.: US 2021/0235505 A1
(43) Pub. Date: Jul. 29, 2021

(54) METHOD AND APPARATUS FOR UPDATING RANDOM-ACCESS REPORT IN WIRELESS MOBILE COMMUNICATION

(71) Applicant: Samsung Electronics Co., Ltd., Suwon-si (KR)

(72) Inventors: June HWANG, Suwon-si (KR); Soenghun KIM, Suwon-si (KR)

(21) Appl. No.: 17/155,859

(22) Filed: Jan. 22, 2021

(30) Foreign Application Priority Data
Jan. 23, 2020 (KR) 10-2020-0009182

(51) Int. Cl. H04W 74/08

(52) U.S. Cl. CPC H04W 74/0833

(57) ABSTRACT

The disclosure relates to a communication technique for convergence between an Internet of things (IoT) technology and a 5^{th} generation (5G) communication system for supporting higher data transmission rate beyond a 4^{th} generation (4G) system, and a system thereof. The disclosure may be applied to intelligence services (e.g., smart homes, smart buildings, smart cities, smart cars or connected cars, healthcare, digital education, retail businesses, security and safety related services, or the like) based on a 5G communication system and an IoT related technology. A method and an apparatus for updating a random-access report in wireless mobile communication are provided.

### CROSS-REFERENCE TO RELATED APPLICATION(S)

This application is based on and claims priority under 35 U.S.C. § 119(a) of a Korean patent application number 10-2020-0009182, filed on Jan. 23, 2020, in the Korean Intellectual Property Office, the disclosure of which is incorporated by reference herein in its entirety.

### BACKGROUND

### 1. Field

The disclosure relates to a terminal and a base station operation in a wireless communication system. More particularly, the disclosure relates to a method and an apparatus for random access reporting in a wireless communication system.

### 2. Description of Related Art

To meet the demand for wireless data traffic having increased since deployment of 4^{th} generation (4G) communication systems, efforts have been made to develop an improved 5^{th} generation (5G) or pre-5G communication system. Therefore, the 5G or pre-5G communication system is also called a “Beyond 4G Network” or a “Post long term evolution (LTE) System”. The 5G communication system is considered to be implemented in higher frequency (millimeter-wave (mmWave)) bands, e.g., 60 gigahertz (GHz) bands, so as to accomplish higher data rates. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G communication systems. In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like. In the 5G system, hybrid frequency shift keying (FSK) and quadrature amplitude modulation (QAM) (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have also been developed.

The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through connection with a cloud server, has emerged. As technology elements, such as “sensing technology”, “wired/wireless communication and network infrastructure”, “service interface technology”, and “security technology” have been demanded for IoT implementation, a sensor network, a machine-to-machine (M2M) communication, machine type communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply 5G communication systems to IoT networks. For example, technologies, such as a sensor network, machine type communication (MTC), and machine-to-machine (M2M) communication may be implemented by beamforming, MIMO, and array antennas. Application of a cloud radio access network (RAN) as the above-described big data processing technology may also be considered an example of convergence of the 5G technology with the IoT technology.

With the advance of wireless communication systems as described above, various services can be provided, and accordingly there is a need for schemes to efficiently provide these services. More particularly, various methods for efficient handover procedures are provided.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and an apparatus related to a random-access channel (RACH) report generation and a VarRACH-report management operation in order to effectively perform random-access reporting in a mobile communication system.

Another aspect of the disclosure is to provide a method and an apparatus related to a RACH report generation and a VarRACH-report management operation in order to effectively perform random-access reporting in a wireless communication system.

Additional aspects will be set forth in part in the description which follows and, in part, will be apparent from the description, or may be learned by practice of the presented embodiments.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure in long term evolution (LTE) system according to an embodiment of the disclosure;

FIG. 2 illustrates a radio protocol structure in an LTE system according to an embodiment of the disclosure;

FIG. 3 illustrates a structure in a next-generation mobile communication system according to an embodiment of the disclosure;

FIG. 4 illustrates a radio protocol structure in a next-generation mobile communication system according to an embodiment of the disclosure;

FIG. 5 illustrates an internal structure of a terminal in a wireless communication system according to an embodiment of the disclosure;

FIG. 6 is a block diagram illustrating a configuration of a new radio (NR) base station in a wireless communication system according to an embodiment of the disclosure;

FIG. 7 illustrates a sequence of a terminal and a base station operation of transmitting a random-access channel (RACH) report in a wireless communication system according to an embodiment of the disclosure;

FIG. 8 illustrates a sequence of a terminal operation of transmitting a delay report related to a RACH report in a wireless communication system according to an embodiment of the disclosure;

FIG. 9 illustrates a sequence of a terminal operation of generating a RACH report and managing a related VarRACH-report variable in a wireless communication system according to an embodiment of the disclosure;

FIG. 10 illustrates a sequence of a terminal operation of generating a RACH report and managing a related VarRACH-report variable in a wireless communication system according to an embodiment of the disclosure;

FIG. 11 illustrates a sequence of a terminal operation of transmitting all RACH reports stored in a variable related to RACH report transmission in a wireless communication system according to an embodiment of the disclosure;

FIG. 12 illustrates a sequence of a terminal operation of transmitting a part of a RACH report stored in a variable related to RACH report transmission in a wireless communication system according to an embodiment of the disclosure;

FIG. 13A illustrates a sequence of a terminal operation relating to a RACH report in a wireless communication system according to an embodiment of the disclosure; and

FIG. 13B illustrates a sequence of a terminal operation relating to a RACH report in a wireless communication system according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Here, it will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operations to be performed on the computer or other programmable apparatus to produce a computer implemented process such that the instructions that execute on the computer or other programmable apparatus provide operations for implementing the functions specified in the flowchart block or blocks.

Further, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the “unit” refers to a software element or a hardware element, such as a field programmable gate array (FPGA) or an application specific integrated circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more central processing units (CPUs) within a device or a security multimedia card. Further, the “unit” in the embodiments may include one or more processors.

In the following description, terms for identifying access nodes, terms referring to network entities, terms referring to messages, terms referring to interfaces between network entities, terms referring to various identification information, and the like are illustratively used for the sake of convenience. Therefore, the disclosure is not limited by the terms as used below, and other terms referring to subjects having equivalent technical meanings may be used. For example, in the following description, the term “terminal” may refer to a medium access control (MAC) entity in each terminal that exists for each of a master cell group (MCG) and a secondary cell group (SCG).

In the following description, the disclosure will be described using terms and names defined in the 3^{rd} generation partnership project long term evolution (3GPP LTE) standards for the convenience of description. However, the disclosure is not limited by these terms and names, and may be applied in the same way to systems that conform other standards.

In the following description, a base station is an entity that allocates resources to terminals, and may be at least one of a next-generation node B (gNode B), an evolved Node B (eNode B), a Node B, a base station (BS), a wireless access unit, a base station controller, and a node on a network. A terminal may include a user equipment (UE), a mobile station (MS), a cellular phone, a smartphone, a computer, or a multimedia system capable of performing communication functions. Examples of the base station and the terminal are not limited thereto.

More particularly, the disclosure may be applied to 3GPP NR (5^{th} generation mobile communication standards). Further, the disclosure may be applied to intelligent services (e.g., smart homes, smart buildings, smart cities, smart cars or connected cars, healthcare, digital education, retail business, security and safety-related services, or the like) based on 5G communication technologies and IoT-related technologies. In the disclosure, the term “eNB” may be interchangeably used with the term “gNB”. For example, a base station described as “eNB” may indicate “gNB”. Further, the term “terminal” may indicate cellular phones, NB-IoT devices, sensors, and other wireless communication devices.

Wireless communication systems have expanded beyond the original role of providing a voice-oriented service and have evolved into wideband wireless communication systems that provide a high-speed and high-quality packet data service according to, for example, communication standards, such as high-speed packet access (HSPA), long-term evolution (LTE or evolved universal terrestrial radio access (E-UTRA)), LTE-Advanced (LTE-A), and LTE-Pro of 3GPP, high-rate packet data (HRPD) and a ultra-mobile broadband (UMB) of 3GPP2, and 802.16e of the institute of electrical and electronics engineers (IEEE).

As a representative example of the broadband wireless communication systems, in an LTE system, an orthogonal frequency-division multiplexing (OFDM) scheme has been adopted for a downlink (DL), and a single carrier frequency division multiple access (SC-FDMA) scheme has been adopted for an uplink (UL). The uplink indicates a radio link through which data or a control signal is transmitted from a terminal (a user equipment (UE), a mobile station (MS), or a terminal) to a base station (an eNode B or a base station (BS)), and the downlink indicates a radio link through which data or a control signal is transmitted from a base station to a terminal. In the above-mentioned multiple-access scheme, normally, data or control information is distinguished according to a user by assigning or managing time-frequency resources for carrying data or control information of each user, wherein the time-frequency resources do not overlap, that is, orthogonality is established.

A future communication system subsequent to the LTE, that is, a 5G communication system, has to be able to freely reflect various requirements from a user, a service provider, and the like, and thus service satisfying all of the various requirements needs to be supported. The services considered for the 5G communication system include enhanced mobile broadband (eMBB), massive machine-type communication (mMTC), ultra-reliable low-latency communication (URLLC), or the like.

According to an embodiment of the disclosure, the eMBB aims to provide a data rate superior to the data rate supported by the existing LTE, LTE-A, or LTE-Pro. For example, in the 5G communication system, the eMBB should be able to provide a peak data rate of 20 gigabytes per second (Gbps) in the downlink and a peak data rate of 10 Gbps in the uplink from the viewpoint of one base station. In addition, the 5G communication system should be able to provide not only the peak data rate but also an increased user-perceived terminal data rate. In order to satisfy such requirements, improvement of various transmitting and receiving technologies including a further improved multi-input multi-output (MIMO) transmission technology may be required in the 5G communication system. In addition, a signal is transmitted using a transmission bandwidth of up to 20 megahertz (MHz) in the 2 gigahertz (GHz) band used by the current LTE, but the 5G communication system uses a bandwidth wider than 20 MHz in the frequency band of 3 to 6 GHz or 6 GHz or higher, thereby satisfying the data rate required in the 5G communication system.

In addition, the mMTC is being considered to support application services, such as the Internet of Things (IoT) in the 5G communication system. The mMTC may be required to support access by a large number of terminals in a cell, coverage enhancement of a terminal, improved battery time, and cost reduction of a terminal in order to efficiently provide the IoT. The IoT needs to be able to support a large number of terminals (for example, 1,000,000 terminals/km²) in a cell because it is attached to various sensors and devices to provide communication functions. Further, a terminal supporting mMTC is more likely to be located in a shaded area that is not covered by a cell due to the nature of services, such as a basement of a building, and thus the terminal requires wider coverage than other services provided in the 5G communication system. The terminal supporting mMTC needs to be configured as an inexpensive terminal and may require a very long battery life time, such as 10 to 15 years, because it is difficult to frequently replace the battery of the terminal.

Finally, the URLLC is a cellular-based wireless communication service used for mission-critical purposes, and may be applied to services used for remote control for a robot or machinery, industrial automation, an unmanned aerial vehicle, remote health care, an emergency alert, or the like. Therefore, the communication provided by the URLLC may provide very low latency (ultra-low latency) and very high reliability (ultra-high reliability). For example, a service that supports the URLLC needs to satisfy air interface latency of less than 0.5 milliseconds, and may also have requirements of a packet error rate of 5-10% or lower. Therefore, for the service that supports the URLLC, the 5G system needs to provide a transmission time interval (TTI) smaller than those of other services, and design matters for allocating wide resources in the frequency band in order to secure reliability of the communication link may also arise.

The above-described three services considered in the 5G communication system, that is, the eMBB, the URLLC, and the mMTC, may be multiplexed and transmitted in a single system. Here, in order to satisfy the different requirements of each of the services, different transmission or reception schemes and different transmission and reception variables may be used for the services. However, the above-described mMTC, URLLC, and eMBB are merely examples of different types of services, and the types of services which are to be applied according to the disclosure are not limited to the above-described examples.

In addition, hereinafter, embodiments of the disclosure will be described by taking an LTE, LTE-A, LTE-Pro, or 5G (or NR, that is, new-generation mobile communication) system as an example, but embodiments of the disclosure may be applied to other communication systems having a similar technical background or channel form. In addition, embodiments of the disclosure may be applied to other communication systems upon determination by those skilled in the art through some modifications without greatly departing from the scope of the disclosure.

The disclosure relates to conditional handover, and an embodiment of the disclosure proposes a method of performing a signal according to a handover condition in a dual connection system and an apparatus related thereto.

According to an embodiment of the disclosure, when a terminal changes a primary secondary cell (PSCell) in a new radio dual connectivity (NR-DC) situation, a network may transmit a particular condition to the terminal in advance. In addition, when the particular condition is satisfied, the terminal that received the particular condition may perform conditional handover.

In addition, according to an embodiment of the disclosure, when the terminal fails to perform conditional handover, in order for the terminal to perform prompt handover to another cell, a signal system related to the network may be proposed.

In addition, according to an embodiment of disclosure, in the terminal for which dual connection is configured, in the case where the terminal changes the PSCell, a signal system between nodes required when a condition related to the conditional handover is transmitted to the terminal may be proposed. In addition, when the terminal for which dual connection is configured fails to change the PSCell, a follow-up operation required for the terminal may be proposed.

In addition, according to an embodiment of the disclosure, the terminal may change a PSCell of a secondary node without error.

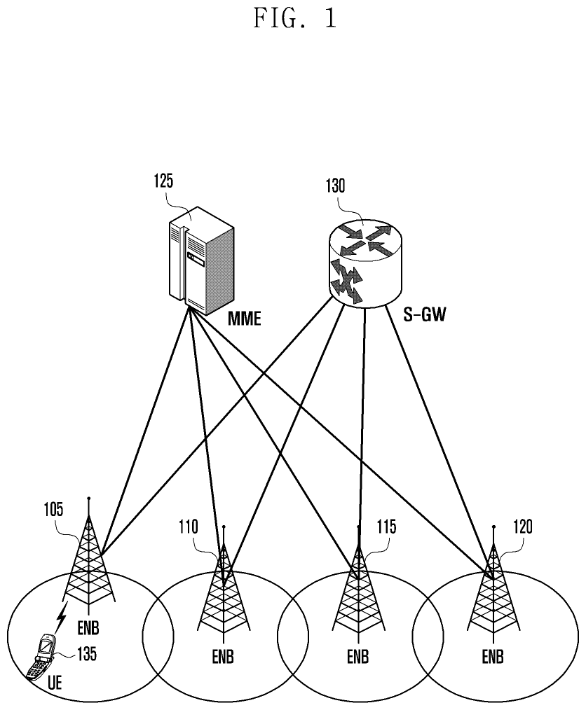

FIG. 1 illustrates a structure in an LTE system according to an embodiment of the disclosure.

Referring to FIG. 1, a wireless access network of the LTE system may include next-generation base stations (evolved Node Bs, hereinafter, referred to as “ENBs”, “Node Bs”, or “base stations”) 105, 110, 115, and 120, a mobility management entity (MME) 125, and a serving-gateway (S-GW) 130. A user equipment (hereinafter, referred to as a “UE” or a “terminal”) 135 may access an external network through the ENBs 105 to 120 and the S-GW 130.

In FIG. 1, the ENBs 105 to 120 may correspond to the existing Node Bs of a universal mobile telecommunication system (UMTS). The ENB may be connected to the UE 135 via a radio channel, and may perform more complex functions than the existing Node B. In the LTE system, all user traffics including real-time services, such as voice over Internet protocol (VoIP) may be serviced through a shared channel. Accordingly, a device for collecting state information, such as buffer state information of UEs, available transmission power state information of UEs, and channel state information of UEs, and performing scheduling may be required, and each of the ENBs 105 to 120 may serve as such a device. A single ENB may generally control multiple cells. For example, the LTE system uses a radio-access technology, such as orthogonal frequency-division multiplexing (OFDM) in a bandwidth of 20 MHz to achieve a data rate of 100 Mbps. In addition, the ENB may also apply an adaptive modulation & coding (AMC) scheme for determining a modulation scheme and a channel-coding rate in accordance with the channel state of a terminal. The S-GW 130 is a device for providing a data bearer, and may generate or release the data bearer under the control of the MME 125. The MME is a device for performing a mobility management function and various control functions for a terminal, and may be connected to multiple base stations.

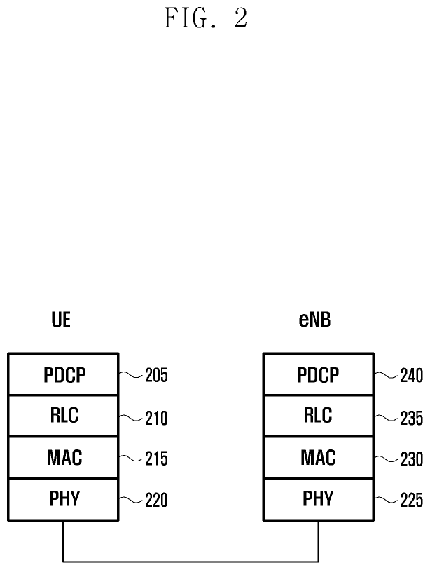

FIG. 2 illustrates a radio protocol structure in an LTE system according to an embodiment of the disclosure.

Referring to FIG. 2, the radio protocol in the LTE system includes packet data convergence protocols (PDCPs) 205 and 240, radio link controls (RLCs) 210 and 235, medium access controls (MACs) 215 and 230, and physical (PHY) devices in a terminal and an ENB, respectively. The PDCPs may perform operations of IP header compression/recovery and the like. The main function of the PDCP is summarized below but are not limited thereto:
Header compression and decompression: robust header compression (ROHC) only
Transfer of user data
In-sequence delivery of upper layer protocol data units (PDUs) at PDCP re-establishment procedure for RLC acknowledged mode (AM)
For split bearers in DC (only support for RLC AM): PDCP PDU routing for transmission and PDCP PDU reordering for reception
Duplicate detection of lower layer SDUs at PDCP re-establishment procedure for RLC AM
Retransmission of PDCP SDUs at handover and, for split bearers in DC, of PDCP PDUs at PDCP data-recovery procedure, for RLC AM
Ciphering and deciphering
Timer-based service data unit (SDU) discard in uplink.

According to an embodiment of the disclosure, the radio link controls (RLCs) 210 and 235 may reconfigure the PDCP protocol data unit (PDU) at an appropriate size to perform an automatic repeat request (ARQ) operation or the like. The main functions of the RLC are summarized below but are not limited thereto:
Transfer of upper layer PDUs
Error Correction through ARQ (only for AM data transfer)
Concatenation, segmentation, and reassembly of RLC SDUs (only for unacknowledged mode (UM) and AM data transfer)
Re-segmentation of RLC data PDUs (only for AM data transfer)
Reordering of RLC data PDUs (only for UM and AM data transfer
Duplicate detection (only for UM and AM data transfer)
Protocol error detection (only for AM data transfer)
RLC SDU discard (only for UM and AM data transfer)
RLC re-establishment.

According to an embodiment of the disclosure, the MACs 215 and 230 are connected to several RLC layer devices configured in one terminal, and may perform an operation of multiplexing RLC PDUs into a MAC PDU and demultiplexing the RLC PDUs from the MAC PDU. The main functions of the MAC are summarized below but are not limited thereto:
Mapping between logical channels and transport channels
Multiplexing/demultiplexing of MAC SDUs belonging to one or different logical channels into/from transport blocks (TB) delivered to/from the physical layer on transport channels
Scheduling information reporting
Error correction through hybrid ARQ (HARQ)
Priority handling between logical channels of one UE
Priority handling between UEs by means of dynamic scheduling
Multimedia broadcast multicast service (MBMS) service identification
Transport format selection
Padding

According to an embodiment of the disclosure, physical layers (PHYs) 220 and 225 may generate an OFDM symbol by performing channel-coding and modulating upper-layer data and transmit the same through a radio channel, or may perform demodulating and channel-decoding the OFDM symbol received through the radio channel and transmit the same to an upper layer.

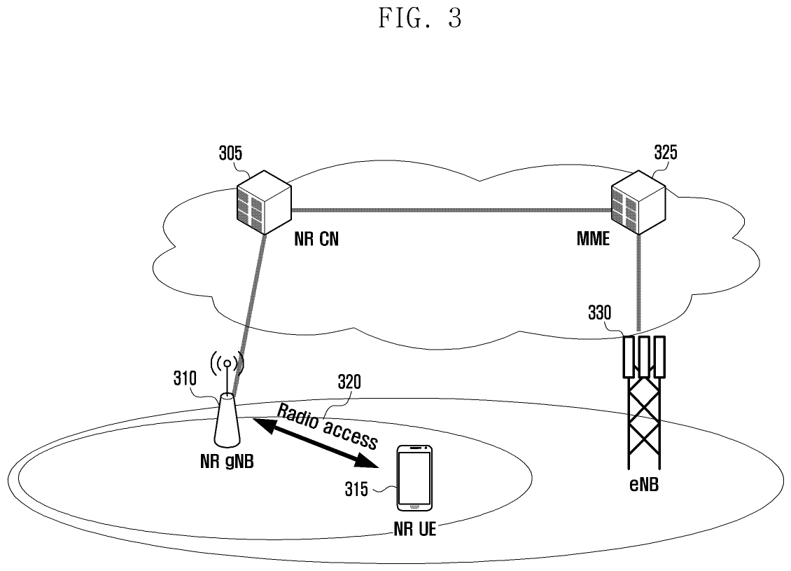

FIG. 3 illustrates a structure in a next-generation mobile communication system according to an embodiment of the disclosure.

Referring to FIG. 3, a radio access network in the next-generation mobile communication system (hereinafter referred to as “new radio (NR)” or 5G) may include a new-radio base station (a new-radio node B, hereinafter, referred to as an “NR gNB” or an “NR base station”) 310 and a new-radio core network (NR CN) 305. A new-radio user equipment (hereinafter, referred to as an “NR UE” or an “NR terminal”) 315 may access an external network through the NR gNB 310 and the NR CN 305.

In FIG. 3, the NR gNB 310 may correspond to an evolved node B (eNB) in the existing LTE system. The NR gNB 310 may be connected to the NR UE 315 through a radio channel, and thus may provide service superior to that of the existing node B. In the next-generation mobile communication system, all user traffic is serviced through shared channels in the next-generation mobile communication system. Accordingly, a device for collecting state information, such as buffer state information of UEs, available transmission power state information of UEs, and channel state information of UEs, and performing scheduling is required, and the NR gNB 310 may serve as such a device. A single NR gNB 310 may generally control multiple cells. In order to implement ultra-high-speed data transmission in the next-generation mobile communication system as compared with the existing LTE, a bandwidth that is equal to or higher than the existing maximum bandwidth may be applied. In addition, a beamforming technology may be additionally combined using orthogonal frequency-division multiplexing (OFDM) as radio connection technology.

In addition, an adaptive modulation & coding (AMC) scheme that determines a modulation scheme and a channel-coding rate in accordance with the channel state of the terminal may be applied. The NR CN 305 may perform a function, such as mobility support, bearer configuration, and quality of service (QoS) configuration. The NR CN 305 is a device that performs not only terminal mobility management functions but also various types of control functions, and may be connected to multiple base stations. Further, the next-generation mobile communication system may be linked with the existing LTE system, and the NR CN 305 may be connected to the MME 325 through a network interface. The MME 325 is connected to an eNB 330, that is, the existing base station.

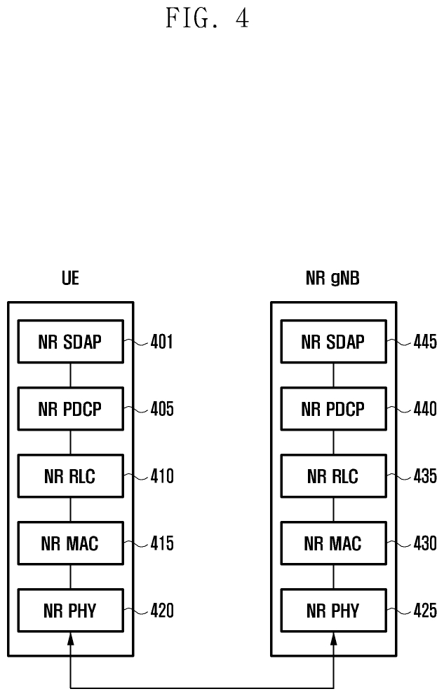

FIG. 4 illustrates a radio protocol structure in a next-generation mobile communication system according to an embodiment of the disclosure.

Referring to FIG. 4, in the radio protocol in the next-generation mobile communication system, a terminal and an NR base station may include NR service data adaptation protocols (SDAPs) 401 and 445, NR PDCPs 405 and 440, NR RLCs 410 and 435, NR MACs 415 and 430, and NR PHYs devices (or layers) 420 and 425, respectively.

According to an embodiment of the disclosure, the main function of the NR SDAPs 401 and 445 may include some of the following functions but are not limited thereto:
Transfer of user plane data
Mapping between a QoS flow and a data radio bearer (DRB) for both DL and UL
Marking QoS flow identity (ID) in both DL and UL packets
Reflective QoS flow to DRB mapping for the UL SDAP PDUs.

For an SDAP-layer device, the terminal may receive, through a radio resource control (RRC) message, a configuration as to whether to use a header of the SDAP-layer device or to use a function of the SDAP-layer device function for each PDCP layer device, each bearer, or each logical channel. When an SDAP header is configured, the terminal may be indicated to update or reconfigure, with a non-access stratum (NAS) reflective QoS 1-bit indicator and an access stratum (AS) reflective QoS 1-bit indicator of the SDAP header, mapping information for uplink and downlink QoS flows and a data bearer. According to an embodiment of the disclosure, the SDAP header may include QoS flow ID information indicating the QoS. According to an embodiment of the disclosure, the QoS information may be used as data-processing priority, scheduling information, or like in order to support a smooth service.

According to an embodiment of the disclosure, the main functions of the NR PDCPs 405 and 440 may include some of the following functions but are not limited thereto:
Header compression and decompression: ROHC only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink.

In the above description, the reordering function of the NR PDCP device may refer to a function of sequentially rearranging PDCP PDUs received in a lower layer, based on a PDCP sequence number (SN). The reordering function of the NR PDCP device may include a function of transferring data to an upper layer in the rearranged order, a function of directly transferring data without considering an order, a function of recording lost PDCP PDUs by rearranging an order, a function of reporting a state of the lost PDCP PDUs to a transmission end, and a function of requesting retransmission of the lost PDCP PDUs.

According to an embodiment of the disclosure, the main function of the NR RLCs 410 and 435 may include some of the following functions but are not limited thereto:
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment.

In the above description, the in-sequence delivery function of the NR RLC device may refer to a function of sequentially transferring RLC SDUs received from a lower layer, to an upper layer. When a single RLC SDU is divided into multiple RLC SDUs and the divided multiple RLC SDUs are received, the in-sequence delivery function of the NR RLC device may include a function of rearranging and transferring the same.

The in-sequence delivery function of the NR RLC device may include a function of rearranging the received RLC PDUs, based on an RLC sequence number (SN) or a PDCP sequence number (SN), a function of recording lost RLC PDUs by rearranging an order, a function of reporting the state of the lost RLC PDUs to a transmission end, and a function of requesting retransmission of the lost RLC PDUs.

When there is a lost RLC SDU, the in-sequence delivery function of the NR RLC device may include a function of sequentially transferring only RLC SDUs preceding the lost RLC SDU to the upper layer.

When there is a lost RLC SDU but the timer expires, the in-sequence delivery function of the NR RLC device may include a function of sequentially transferring all RLC SDUs received before a predetermined timer starts to the upper layer.

When there is a lost RLC SDU but the predetermined timer expires, the in-sequence delivery function of the NR RLC device may include a function of transferring all RLC SDUs received up to that point in time to the upper layer.

The NR RLC device may process the RLC PDUs in the received order regardless of the order of serial numbers or sequence numbers, and may deliver the processed RLC PDUs to the NR PDCP device.

When the NR RLC device receives a segment, the NR RLC may receive segments which are stored in a buffer or are to be received later, reconfigure the segments into one complete RLC PDU, and then deliver the same to the NR PDCP device.

The NR RLC layer may not include a concatenation function and may perform the function in the NR MAC layer or may replace the function with a multiplexing function of the NR MAC layer.

In the above description, the out-of-sequence delivery function of the NR RLC device may refer to a function of directly delivering, to the upper layer regardless of order, the RLC SDUs received from the lower layer. When a single RLC SDU is divided into multiple RLC SDUs and the divided multiple RLC SDUs are received, the out-of-sequence delivery function of the NR RLC device may include a function of rearranging and transferring the divided multiple RLC SDUs. The out-of-sequence delivery function of the NR RLC device may include a function of storing the PDCP SN or the RLC SN of each of the received RLC PDUs, arranging the RLC PDUs, and recording the lost RLC PDUs.

According to an embodiment of the disclosure, the NR MAC 415 and 430 may be connected to several NR RLC layer devices configured in one terminal, and the main functions of the NR MAC may include some of the following functions but are not limited thereto:
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

NR Physical layers (NR PHYs) 420 and 425 may generate an OFDM symbol by performing channel-coding and modulating upper-layer data and transmit the same through a radio channel, or may perform demodulating and channel-decoding the OFDM symbol received through the radio channel and transmit the same to the upper layer.

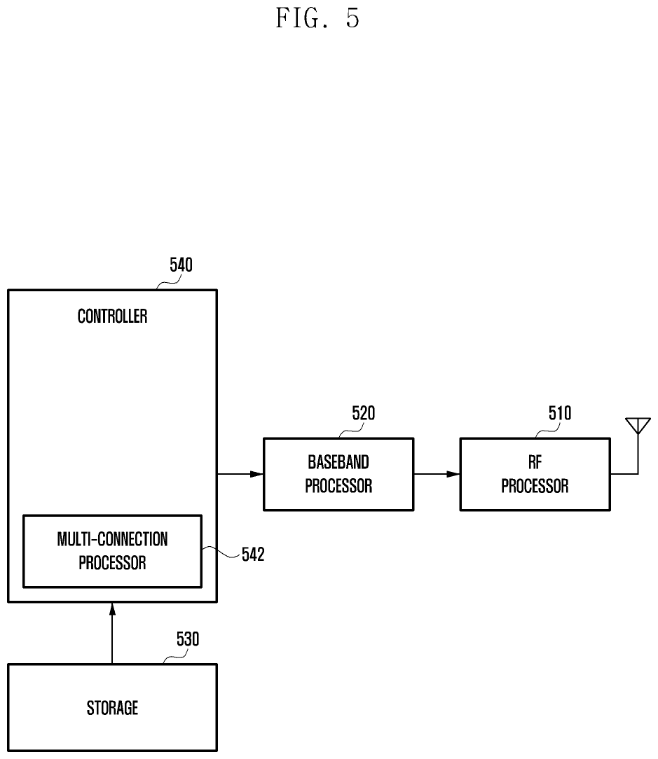

FIG. 5 illustrates an internal structure of a terminal in a wireless communication system according to an embodiment of the disclosure.

Referring to FIG. 5, the terminal may include a radio frequency (RF) processor 510, a baseband processor 520, a storage 530, and a controller 540 containing a multi-connection processor 542, but is not limited thereto and the terminal may include a configuration having a smaller configuration shown in FIG. 5 or may include more configurations.

The RF processor 510 may perform a function for transmitting or receiving a signal through a radio channel, such as signal band conversion, amplification, and the like. For example, the RF processor 510 may up-convert a baseband signal, provided from the baseband processor 520, to an RF-band signal and then transmit the RF-band signal through an antenna, and down-convert an RF-band signal received through an antenna into a baseband signal. For example, the RF processor 510 may include a transmission filter, a reception filter, an amplifier, a mixer, an oscillator, a digital-to-analog converter (DAC), an analog-to-digital converter (ADC), and the like, but are not limited thereto. Although only a single antenna is illustrated in FIG. 5, the terminal may include multiple antennas. In addition, the RF processor 510 may include multiple RF chains. Furthermore, the RF processor 510 may perform beamforming. For beamforming, the RF processor 510 may adjust the phases and amplitudes of signals transmitted or received through multiple antennas or antenna elements. The RF processor 510 may also perform MIMO and may receive data of multiple layers of data during the MIMO operation.

The baseband processor 520 performs a function of conversion between a baseband signal and a bitstream according to the physical layer specifications of a system. For example, during data transmission, the baseband processor 520 generates complex symbols by encoding and modulating a transmission bitstream. In addition, during data reception, the baseband processor 520 may reconstruct a received bitstream by demodulating and decoding a baseband signal provided from the RF processor 510. For example, according to an orthogonal frequency-division multiplexing (OFDM) scheme, during data transmission, the baseband processor 520 generates complex symbols by encoding and modulating a transmission bitstream, maps the complex symbols to subcarriers, and then configures OFDM symbols by performing inverse fast Fourier transformation (IFFT) operation and cyclic prefix (CP) insertion. Further, during data reception, the baseband processor 520 may segment a baseband signal, provided from the RF processor 510, into units of OFDM symbols, reconstruct signals mapped to subcarriers by performing a fast Fourier transformation (FFT) operation, and then reconstruct a received bitstream by demodulating and decoding the signals.

The baseband processor 520 and the RF processor 510 transmit and receive signals as described above. Accordingly, each of the baseband processor 520 and the RF processor 510 may also be referred to as a transmitter, a receiver, a transceiver, or a communication unit. Furthermore, at least one of the baseband processor 520 and the RF processor 510 may include multiple communication modules to support multiple different radio-access technologies. In addition, at least one of the baseband processor 520 and the RF processor 510 may include multiple communication modules to process signals of different frequency bands. For example, the different radio-access technologies may include a wireless local area network (LAN) (e.g., IEEE 802.11), a cellular network (e.g., LTE), and the like. In addition, the different frequency bands may include a super-high frequency (SHF) (e.g., 2·NRHz, NRhz) band and a millimeter-wave (mmWave) (e.g., 60 GHz) band. The terminal may transmit or receive a signal to or from the base station by using the baseband processor 520 and the RF processor 510, and the signal may include control information and data.

The storage 530 stores data, such as basic programs, applications, configuration information, or the like for the operation of the terminal. Specifically, the storage 530 may store information related to a second connection node for performing wireless communication by using a second wireless connection technology. In addition, the storage 530 provides the stored data in response to a request from the controller 540. The storage 530 may include a storage medium, such as read only memory (ROM), random access memory (RAM), a hard disk, a compact disc (CD)-ROM, and a digital versatile disc (DVD) and a combination of storage media. In addition, the storage 530 may also include multiple memories.

The controller 540 controls the overall operation of the terminal. For example, the controller 540 transmits or receives signals through the baseband processor 520 and the RF processor 510. Further, the controller 540 records and reads data on or from the storage 530. To this end, the controller 540 may include at least one processor. For example, the controller 540 may include a communication processor (CP) for controlling communication and an application processor (AP) for controlling an upper layer, such as an application. At least one element of the terminal may be implemented in a single chip.

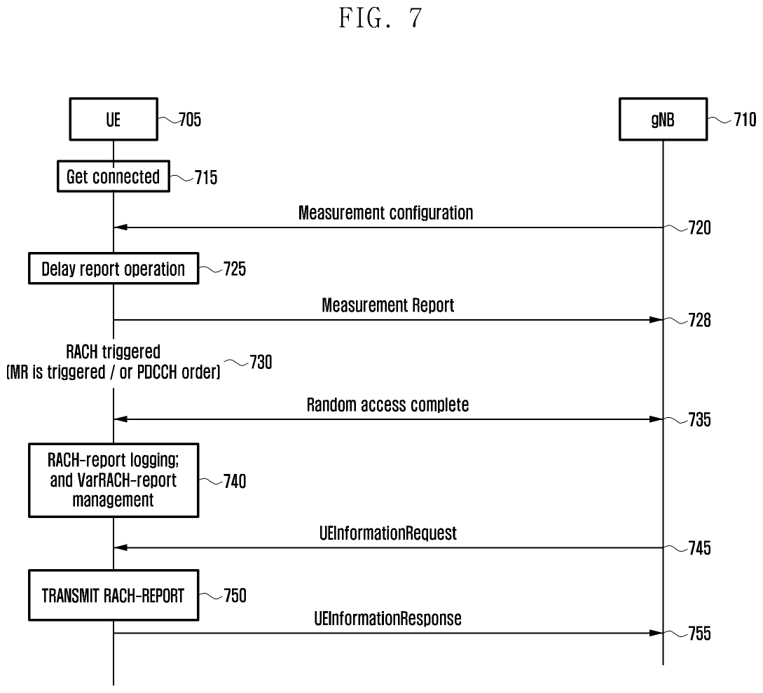

According to an embodiment of the disclosure, the controller 540 may control each element of the terminal in order to perform a handover method according to an embodiment of the disclosure. The handover method of the disclosure will be described in FIGS. 7 to 10 below.

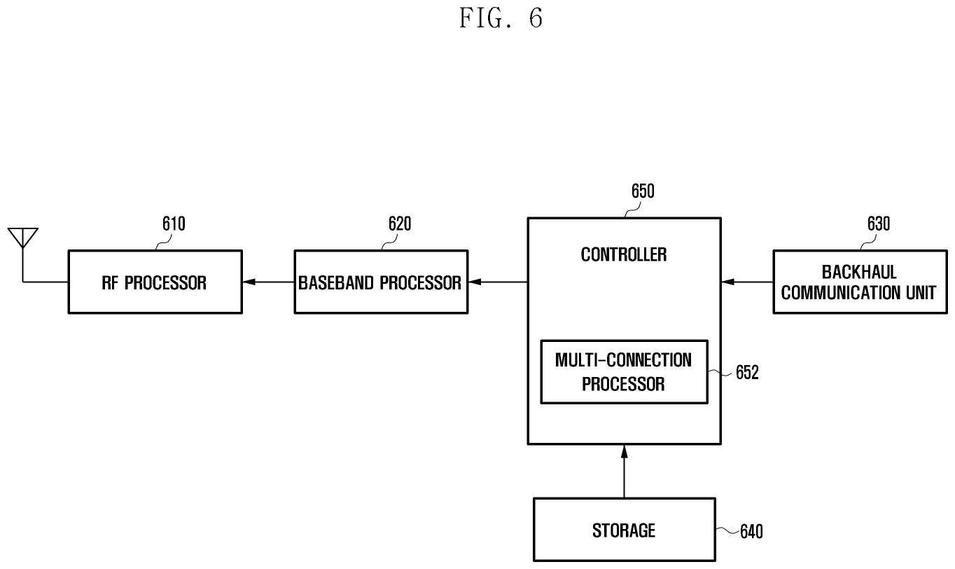

FIG. 6 is a block diagram illustrating a configuration of an NR base station in a wireless communication system according to an embodiment of the disclosure.

Referring to FIG. 6, the base station includes an RF processor 610, a baseband processor 620, a backhaul communication unit 630, a storage 640, and a controller 650 containing a multi-connection processor 652, but is not limited thereto and the terminal may include a configuration having a smaller configuration shown in FIG. 6 or may include more configurations.

The RF processor 610 may perform a function of transmitting or receiving a signal through a radio channel, such as signal band conversion and amplification. For example, the RF processor 610 up-converts a baseband signal, provided from the baseband processor 620, to an RF-band signal and transmits the converted RF-band signal through an antenna, and down-converts an RF-band signal received through an antenna to a baseband signal. For example, the RF processor 610 may include a transmission filter, a reception filter, an amplifier, a mixer, an oscillator, a DAC, an ADC, and the like. Although only a single antenna is illustrated in FIG. 6, the RF processor 610 may include multiple antennas. In addition, the RF processor 610 may include multiple RF chains. Furthermore, the RF processor 610 may perform beamforming. For beamforming, the RF processor 610 may adjust phases and amplitudes of signals transmitted or received through multiple antennas or antenna elements. The RF processor 610 may perform downlink MIMO operation by transmitting data of one or more layers.

The baseband processor 620 may perform conversion between a baseband signal and a bitstream based on the physical layer specifications of a first radio-access technology. For example, during data transmission, the baseband processor 620 may generate complex symbols by encoding and modulating a transmission bitstream. In addition, during data reception, the baseband processor 620 may reconstruct a received bitstream by demodulating and decoding a baseband signal provided from the RF processor 610. For example, according to an OFDM scheme, during data transmission, the baseband processor 620 generates complex symbols by encoding and modulating a transmission bitstream, maps the complex symbols to subcarriers, and then configures OFDM symbols by performing IFFT operation and CP insertion. Further, during data reception, the baseband processor 620 may segment a baseband signal, provided from the RF processor 610, into units of OFDM symbols, reconstructs signals mapped to subcarriers by performing FFT operation, and then reconstruct a received bitstream by demodulating and decoding the signals. The baseband processor 620 and the RF processor 610 may transmit and receive signals as described above. Accordingly, each of the baseband processor 620 and the RF processor 610 may also be referred to as a transmitter, a receiver, a transceiver, a communication unit, or a wireless communication unit. The base station may transmit or receive a signal to or from the terminal by using the baseband processor 620 and the RF processor 610, and the signal may include control information and data.

The backhaul communication unit 630 provides an interface for communicating with other nodes in a network. For example, the backhaul communication unit 630 may convert a bitstream transmitted from a primary base station to another node, for example, the secondary base station, the core network, and the like, into a physical signal, and may convert a physical signal received from another node into a bitstream. The backhaul communication unit 630 may be included in a communication unit.

The storage 640 stores data, such as basic programs, applications, configuration information, or the like for the operation of the primary base station. The storage 640 may store information related to a bearer allocated to a connected terminal, the result of measurement reported from the connected terminal, and the like. In addition, the storage 640 may store information which serves as criteria for determining whether or not to provide multi-connectivity to the terminal. Further, the storage 640 provides the stored data in response to a request from the controller 650. The storage 640 may include a storage medium, such as ROM, RAM, a hard disk, a CD-ROM, and a DVD and a combination of storage media. In addition, the storage 640 may also include multiple memories.

The controller 650 controls the overall operation of the base station. For example, the controller 650 transmits or receives a signal through the baseband processor 620 and the RF processor 610 or through the backhaul communication unit 630. In addition, the controller 650 records and reads data on or from the storage 640. To this end, the controller 650 may include at least one processor. In addition, at least one element of the base station may be implemented in a single chip.

FIG. 7 illustrates a sequence of a terminal and a base station operation of transmitting a random-access channel (RACH) report in a wireless communication system according to an embodiment of the disclosure.

Referring to FIG. 7, a wireless access state of a terminal 705 may be in an RRC idle state or an RRC inactive state and then cell reselection may be performed for a particular base station 710, and the wireless access state of the terminal 705 may be changed to an RRC-connected state by performing a connection operation at operation 715. In the state of the connected mode, the terminal may receive measurement configuration information from the base station at operation 720. Accordingly, the terminal may receive configuration information relating to an uplink (UL) delay report. When the configuration information is received, the terminal may measure a delay with respect to a data radio bearer (DRB) to which the corresponding configuration is made at operation 725, and may perform an operation of reporting related measurement information to the base station 710 at operation 728.

When the terminal 705 has an insufficient resource for uplink data transmission, or the terminal 705 has received a random-access command from the base station at operation 730, the terminal may perform random access at operation 735. When a random-access procedure is completed, the terminal may generate a RACH report and update or amend a VarRACH-report variable at operation 740.

The base station 710 may request a RACH report from the terminal 705 through a UEInformationRequest message at operation 745. When the message includes an indicator requesting a RACH report, the terminal may identify the currently storing VarRACH-report variable and transmit a RACH report to the base station with reference to RACH report information in the VarRACH-report variable at operation 750. In this case, the terminal may add the content to be transmitted to a UEInformationResponse message and transmit the message to the base station at operation 755.

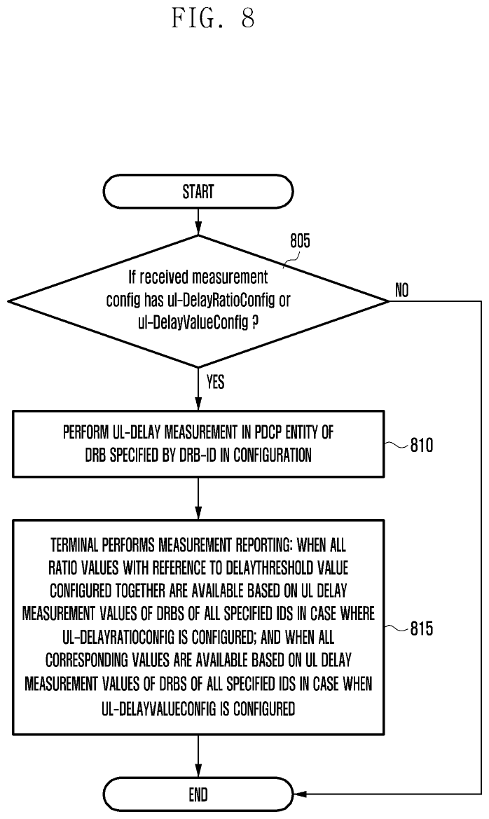

FIG. 8 illustrates a sequence of a terminal operation of transmitting a delay report related to a RACH report in a wireless communication system according to an embodiment of the disclosure.

When the terminal receives measurement configuration information relating to an uplink (UL) delay report from the base station in FIG. 7, the terminal may receive a configuration relating to delay measurement at operation 720. In this case, the terminal may perform the following operation.

Referring to FIG. 8, the received measurement configuration information may include an uplink delay ratio configuration report indicator (UL-DelayRatioConfig). In addition, the received measurement configuration information may include multiple DRB identities (DRB IDs) and uplink delay threshold information. Furthermore, the received measurement configuration information may include an uplink delay value configuration report indicator (UL-DelayValueConfig) at operation 805.

When the measurement configuration information includes the uplink delay ratio configuration report indicator or the multiple DRB IDs and the uplink delay threshold information, the terminal may specify a DRB by using the DRB IDs included in the measurement configuration information. In addition, uplink delay (UL delay) measurement may be performed in a PDCP entity of the specified DRB at operation 810.

While the terminal performs uplink delay measurement in the PDCP entity of the specified DRB, an uplink delay measurement report maybe triggered when the following conditions are satisfied at operation 815.

In the following description, the ratio may mean a value of a ratio of the number of packets exceeding a delayThreshold value to the total generated packet number. When the ratio is equal to or greater than the uplink delay ratio included in the measurement configuration information, it is represented that the ratio is available. When the ratio is available, uplink delay measurement reporting may be triggered.

Alternatively, the meaning that the ratio is available may mean a case in which the ratio value is actually derived from PDCP. A case in which a value can be derived from PDCP can be expressed as available in RRC.
The case where the received measurement configuration information includes an uplink delay ratio configuration report indicator, and all ratio values of the DRBs of all IDs, the DRBs being specified at the time of measurement configuration, are available based on a UL delay measurement value, that is, the case where all ratio values, each of which indicates a ratio of the number of packets exceeding the delayThreshold value configured together at the time of measurement configuration to the total generated packet number are available (that is, the case where a ratio value indicating a ratio of the number of packets delayed at each DRB to the total generated packet number is generated)
The case where the received measurement configuration information includes an uplink delay ratio configuration report indicator, and a representative value of ratio values of DRBs of all IDs specified at the time of measurement configuration is available based on a UL delay measurement value, that is, the case where a representative value of a ratio value which indicates a ratio of the number of packets exceeding the delayThreshold value configured together at the time of measurement configuration to the total generated packet number is available (wherein the ratio representative value may mean an average of ratio values, each of which indicates a ratio of the number of packets delayed at each DRB to the total generated packet number)
The case where the received measurement configuration information includes an uplink delay ratio configuration report indicator, and a ratio value of at least one DRB specified at the time of measurement configuration is available based on UL delay measurement value, that is, the case where a value of a ratio of the number of packets exceeding the delayThreshold value configured together at the time of measurement configuration to the total generated packet number is available (that is, the case where a ratio value is generated in at least one DRB)

According to an embodiment of the disclosure, the received measurement configuration information may have a UL delay ratio configuration report indicator at operation 805.

When the received measurement configuration information includes multiple DRB IDs, the terminal may specify a DRB, based on a DRB-ID included in the measurement configuration information. In addition, the terminal may perform UL delay measurement in a PDCP entity of the specified DRB at operation 810.

While the terminal performs UL delay measurement in the PDCP entity of the specified DRB, UL delay measurement reporting may be triggered when the following conditions are satisfied.

In the following description, when a UL delay measurement value is equal to or greater than a value according to uplink delay value configuration included in the measurement configuration information, it is represented that a delay value is available.

Alternatively, the meaning that the delay value is available may mean a case in which the delay value is actually derived from PDCP. A case in which a value can be derived from PDCP can be expressed as available in RRC.
The case where the received measurement configuration information includes an uplink delay value configuration report indicator, and a delay value is available for each DRB, based on a UL delay measurement value with respect to DRBs of all IDs specified at the time of measurement configuration
The case where the received measurement configuration information includes an uplink delay value configuration report indicator, and one representative delay value is available based on a UL delay measurement value with respect to DRBs of all IDs specified at the time of measurement configuration (wherein the representative delay value may mean an average of delay values measured for each DRB)

In the above-described cases, the terminal may generate a measurement report, include the corresponding delay ratio value(s) or delay value(s) in the measurement report, and transmit the same to the base station at operation 815.

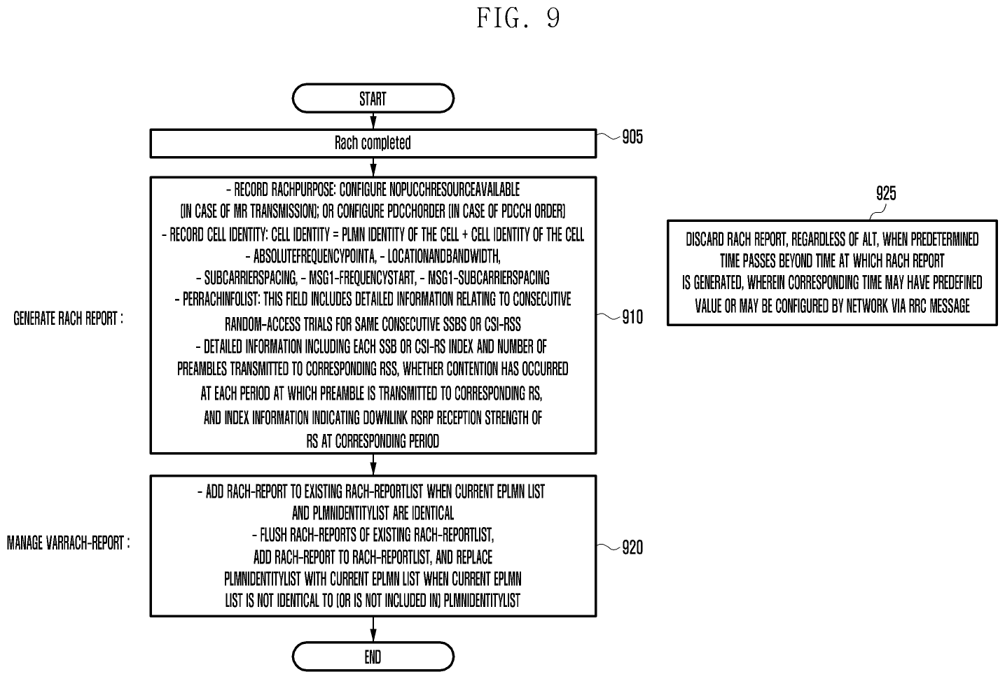

FIG. 9 illustrates a sequence of a terminal operation of generating a RACH report and managing a related VarRACH-report variable in a wireless communication system according to an embodiment of the disclosure.

When the terminal has completed performing random access with respect to the base station, the terminal may generate a RACH report and update or manage a VarRACH-report variable.

Referring to FIG. 9, when the terminal has completed random access at operation 905, the terminal may generate a report relating to the completed RACH. Each RACH report may include the following content.
RACH purpose: This means a purpose of performing random access by the terminal. There are various cases of purposes of performing random access by the terminal. Due to the shortage of an uplink resource for measurement report (MR) transmission, or in order to acquire an uplink resource for other purposes, the terminal may perform random access. In this case, a purpose value may be configured to be “noPUCCHResourceAvailable”. Alternatively, when the base station has instructed random access to the terminal via a physical downlink control channel (PDCCH), a purpose value may be configured to be “pdcchOrder”. Additionally, depending on the uses of the purpose value, the purpose value may be configured based on the following uses “accessRelated” for the use of initial access, “beamFailureRecovery” for the use of informing network of beam failure, “reconfigurationWithSync” for the use of target cell access during handover, “ulUnSynchronized,” “schedulingRequestFailure” for the use of informing of scheduling request failure,” “sCellAdditionTAAdjustment” for the use of SCell addition and timing adjustment, and “requestForOtherSI” for the use for requesting system information.
cell identity: This indicates an identity of a cell in which the terminal has performed random access, and may include a cell identity. The cell identity may include a public land mobile network (PLMN) identity of a cell, in which a RACH has been completed, and a cell identity of the corresponding cell. A combination of a physical cell ID and a base station ID may be one example of the cell identity. Alternatively, the cell identity may be a specific identity which can distinguish one cell in a PLMN in a unique manner. In addition, the cell identity may mean a cell global identifier (NR CGI).
absoluteFrequencyPointA: This indicates absolute frequency position information of a cell in which random access is performed, and may be an absolute frequency position of the reference resource block.
locationAndBandwidth: This is a value represented in an integral value, and may be a frequency-domain location and bandwidth of the bandwidth part associated to the random-access resources used by the UE.
subcarrierSpacing: This means subcarrier spacing information used in a bandwidth part (BWP) in which the terminal has performed random access.
msg1-FrequencyStart: This is a value represented in an integral value, and may be an offset of the lowest physical random access channel (PRACH) transmission occasion in the frequency domain with respective to physical resource block (PRB) 0 of the UL BWP.
msg1-SubcarrierSpacing: This means subcarrier spacing of PRACH resources information.
perRACHInfoList: This means information representing detailed information on each trial during random access in chronological order. This may represent detailed information on a reference signal considered at each trial. This field may include detailed information of consecutive random access trials for the same consecutive synchronization signal blocks (SSBs) or channel state information reference signals (CSI-RSs). The detailed information includes each SSB or CSI-RS index and the number of preambles transmitted to the corresponding RSs, whether contention has occurred at each period at which a preamble is transmitted to the corresponding RS, and index information indicating a downlink reference signal received power (RSRP) reception strength of RS at the corresponding period.

The terminal may generate the RACH report at operation 910 and update or amend the VarRACH-Report as described in the following description at operation 920. When an equivalent public land mobile network (EPLMN) list currently stored in the terminal and plmnIdentityList stored in the existing VarRACH-Report variable are identical, or when the EPLMN list currently stored in the terminal is included in the plmnIdentityList stored in the existing VarRACH-Report variable, the terminal may add the generated RACH-report to the existing RACH-ReportList stored in the VarRACH-Report. In addition, the terminal may not change the plmnIdentityList of the VarRACH-Report variable.

When an EPLMN list currently stored in the terminal and the plmnIdentityList stored in the existing VarRACH-Report variable are not identical, or when the EPLMN list currently stored in the terminal is not included in the plmnIdentityList stored in the existing VarRACH-Report variable, the terminal may flush all RACH-reports stored in the RACH-report list stored in the existing VarRACH-Report variable, and newly add the most recent RACH report generated in operation 910 to the RACH-ReportList of the VarRACH-Report variable. In addition, the terminal may replace the plmnIdentityList of the VarRACH-Report with the EPMN list currently stored in the terminal at operation 920.

According to another embodiment of the disclosure, the terminal may discard the RACH report generated according to each random access trial from the VarRACH-Report list when a predetermined time passes at operation 925.

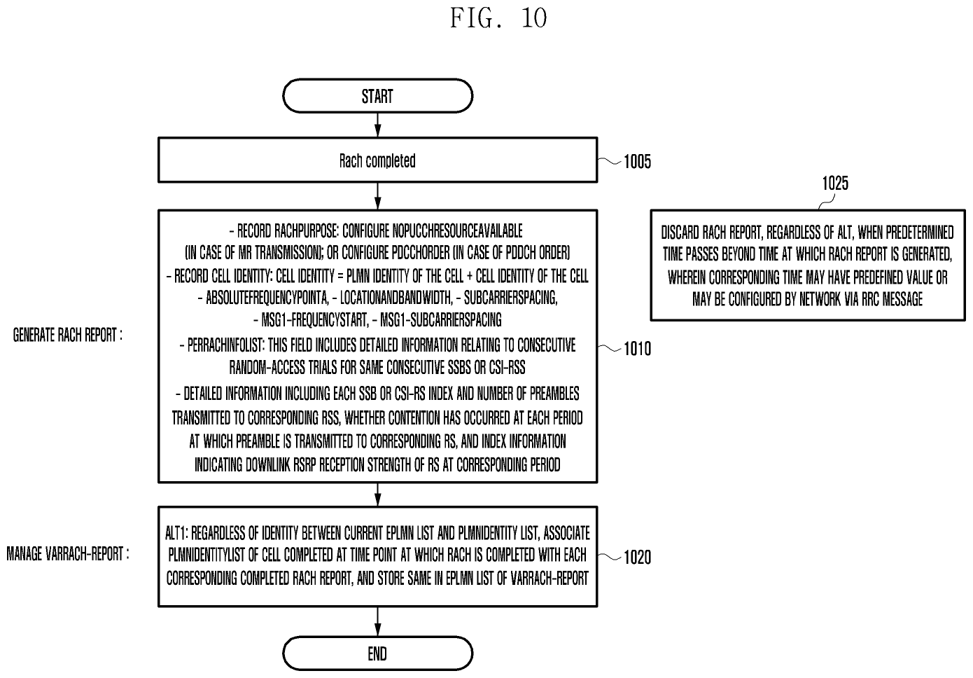

FIG. 10 illustrates a sequence of a terminal operation of generating a RACH report and managing a related VarRACH-report variable in a wireless communication system according to an embodiment of the disclosure.

When the terminal has completed performing random access with respect to the base station, the terminal may generate a RACH report and update or manage a VarRACH-report variable.

Referring to FIG. 10, when the terminal has completed random access at operation 1005, the terminal may generate a report relating to the completed RACH. Each RACH report may include the following content.
RACH purpose: This means a purpose of performing random access by the terminal. There are various cases of purposes of performing random access by the terminal. Due to the shortage of an uplink resource for measurement report (MR) transmission, or in order to acquire an uplink resource for other purposes, the terminal may perform random access. In this case, a purpose value may be configured to be “noPUCCHResourceAvailable”. Alternatively, when the base station has instructed random access to the terminal via a PDCCH, a purpose value may be configured to be “pdcchOrder”. Additionally, depending on the uses of the purpose value, the purpose value may be configured based on the following uses: “accessRelated” for the use of initial access, “beamFailureRecovery” for the use of informing network of beam failure, “reconfigurationWithSync” for the use of target cell access during handover, “ulUnSynchronized”, “schedulingRequestFailure” for the use of informing of scheduling request failure”, “sCellAdditionTAAdjustment” for the use of SCell addition and timing adjustment, and “requestForOtherSI” for the use for requesting system information.
cell identity: This indicates an identity of a cell in which the terminal has performed random access, and may include a cell identity. The cell identity may include a PLMN identity of a cell, in which a RACH has been completed, and a cell identity of the corresponding cell. A combination of a physical cell ID and a base station ID may be one example of the cell identity. Alternatively, the cell identity may be a specific identity which can distinguish one cell in a PLMN in a unique manner. In addition, the cell identity may mean an NR CGI.
absoluteFrequencyPointA: This indicates absolute frequency position information of a cell in which random access is performed, and may be an absolute frequency position of the reference resource block.
locationAndBandwidth: This is a value represented in an integral value, and may be a frequency-domain location and bandwidth of the bandwidth part associated to the random-access resources used by the UE.
subcarrierSpacing: This means subcarrier spacing information used in a BWP in which the terminal has performed random access.
msg1-FrequencyStart: This is a value represented in an integral value, and may be an offset of the lowest PRACH transmission occasion in the frequency domain with respective to PRB 0 of the UL BWP.
msg1-SubcarrierSpacing: This means subcarrier spacing of PRACH resources information.
perRACHInfoList: This means information representing detailed information on each trial during random access in chronological order. This may represent detailed information on a reference signal considered at each trial. This field may include detailed information of consecutive random access trials for the same consecutive SSBs or CSI-RSs. The detailed information includes each SSB or CSI-RS index and the number of preambles transmitted to the corresponding RSs, whether contention has occurred at each period at which a preamble is transmitted to the corresponding RS, and index information indicating a downlink RSRP reception strength of RS at the corresponding period.

The terminal may generate the RACH report at operation 1010 and update or amend the VarRACH-Report as described in the following description at operation 1020. The terminal may add the EPLMN list to a separate entry according to the RACH report generated in the plmnIdentityList of the VarRACH-report. In addition, the terminal may add the generated RACH report to the RACH report list of the VarRACH-report. An element of the added plmnIdentityList and an element added to the RACH report list should be associated with each other. For example, two elements should have the same entry order.

According to another embodiment of the disclosure, when an EPLMN list for the multiple generated RACH reports are identical, the corresponding RACH reports may be associated with one EPLMN regardless of the entry order, and an ID of the EPLMN list to which each RACH report is associated may be given.

According to another embodiment of the disclosure, the terminal may discard the RACH report generated according to each random-access trial from the VarRACH-Report when a predetermined time passes. In this case, the EPLMN list associated with each discarded RACH report may be also discarded at operation 1025.

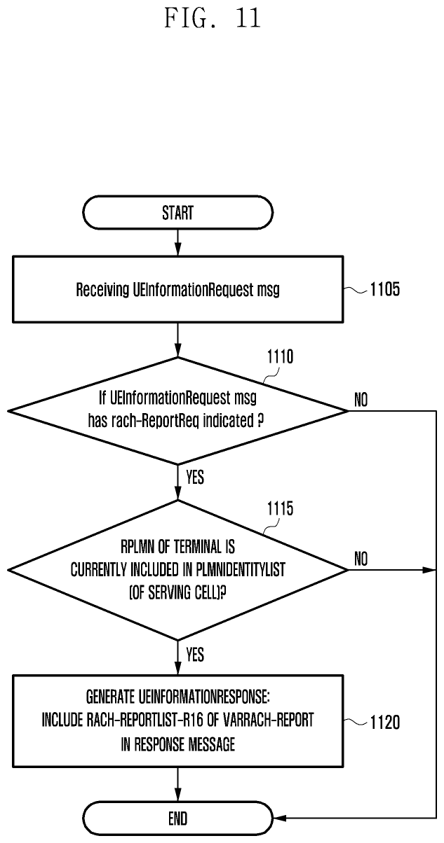

FIG. 11 illustrates a sequence of a terminal operation of transmitting all RACH reports stored in a variable related to RACH report transmission in a wireless communication system according to an embodiment of the disclosure.

Referring to FIG. 11, the terminal may receive a UEInformationRequest message from the base station (alternatively, the UEInformationRequest message may be replaced with a predetermined RRC-dedicated signaling message) at operation 1105. When the received message includes an indicator requesting a RACH report (RACH-ReportReq) at operation 1110 and a VarRACH-report includes any content, the terminal may determine whether a registered PLMN (RPLMN) is included in plmnIdentityList of the VarRACH-Report at operation 1115.

When the RPLMN of the terminal is currently included in the plmnIdentityList of the VarRACH-Report, the terminal may add a RACH-Report List stored in the VarRACH-Report to a message at the time of UEInformationResponse message generation at operation 1120. When the successful transmission of the UEInformationResponse message is identified from the lower layer, the terminal may discard the content of the corresponding RACH-Report List.

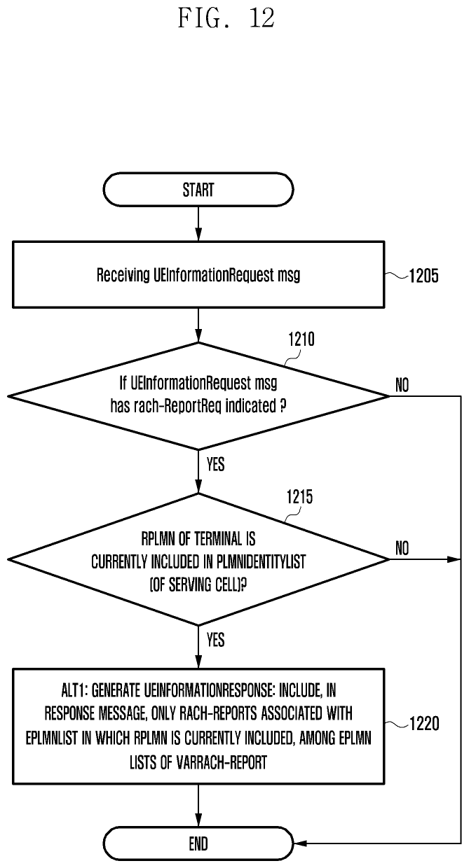

FIG. 12 illustrates a sequence of a terminal operation of transmitting a part of a RACH report stored in a variable related to RACH report transmission in a wireless communication system according to an embodiment of the disclosure.

When operation 1020 in FIG. 10 has been performed in the previous operation, the following embodiment may be performed.

Referring to FIG. 12, the terminal may receive a UEInformationRequest message from a base station (alternatively, the UEInformationRequest message may be replaced with a predetermined RRC-dedicated signaling message) at operation 1205. When the received message includes an indicator requesting a RACH report (RACH-ReportReq) at operation 1210, and a VarRACH-report includes any content, the terminal may determine whether an RPLMN of the terminal is currently included in plmnIdentityList of the VarRACH-Report at operation 1215.

When the RPLMN of the terminal is currently included in the plmnIdentityList of the VarRACH-Report, the terminal may include, in a response message, RACH reports associated with an entry in which the RPLMN is currently included, among entries of the plmnIdentityList of the VarRACH-report (or entries in the RACH-report List in the same order) when generating a UEInformationResponse message at operation 1220. In this case, the plmnIdentityList of the corresponding entry may be also included in the UEInformationResponse together with each associated RACH report. When the successful transmission of the UEInformationResponse message is identified from the lower layer, the terminal may discard the content of the plmnIdentityList and the corresponding RACH-Report from the VarRACH-Report variable.

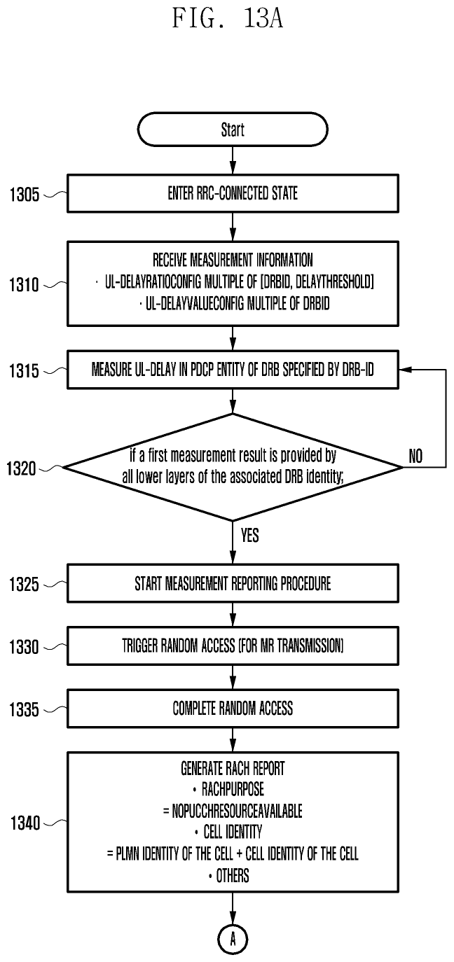

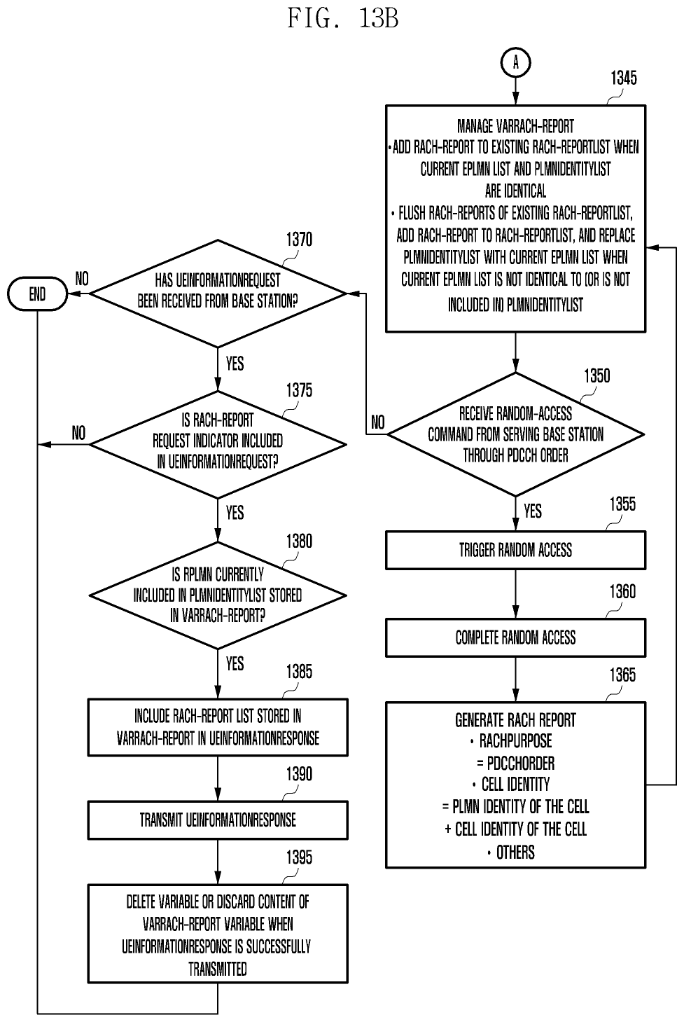

FIG. 13A illustrates a sequence of a terminal operation relating to a RACH report in a wireless communication system according to an embodiment of the disclosure.

FIG. 13B illustrates a sequence of a terminal operation relating to a RACH report in a wireless communication system according to an embodiment of the disclosure.

Referring to FIG. 13A, when the terminal enters an RRC-connected state at operation 1305, the terminal may receive measurement configuration information from the base station at operation 1310. The configuration information may include an indicator indicating reporting of a UL delay ratio or a UL delay value.

The UL delay ratio configuration information may include multiple DRB IDs and UL delay threshold information to determine a ratio for each DRB. When the indicator is included, the terminal may measure a UL delay in a PDCP entity of a DRB specified by each DRB-ID at operation 1315. When ratio values are derived from all PDCP entities, the terminal may start measurement reporting operation at operation 1325.

The UL delay value configuration information may also include multiple DRB-IDs. When the terminal receives UL delay value configuration information, the terminal may measure a UL delay in a PDCP entity of a DRB specified by each DRB-ID. When delay values are derived from all PDCP entities, the terminal may start measurement reporting operation at operation 1325. Operation 1320 may be replaced with the operation illustrated in FIG. 8, other than the operation above.

When the terminal starts the measurement reporting operation and has no uplink resource for transmission, the terminal may perform random access to request a resource at operation 1330. When the random access is completed at operation 1335, the terminal may generate a RACH report at operation 1340 and manage a Var-RACH-report at operation 1345. Operation 1340 may be replaced with operation 910 in FIG. 9, operation 1010 in FIG. 10, or other embodiments described above. Since the RACH performance is caused by the shortage of a resource for MR transmission, noPUCCHResourceAvailabe may be included in the purpose field of the RACH report.

Operation 1345 may be replaced with operation 920 in FIG. 9, operation 1020 in FIG. 10, or other embodiments described above.

Referring to FIG. 13B, when the terminal is instructed, by a serving base station via a PDCCH, to trigger random access after operations of RACH performance completion, RACH report generation, and VarRACH-Report management are completed at operation 1350, the terminal may perform random access at operation 1355. When the random access is completed at operation 1360, the terminal may generate a RACH report. In this case, the purpose may be indicated to be “pdcchOrder”, and the remaining operation may be the same as operation 1340. In addition, the terminal may perform VarRACH-Report management based on the generated RACH-report at operation 1365.

When the terminal receives a UEInformationRequest message from the base station later at operation 1370, the terminal may identify whether the message includes an indicator requesting a RACH report at operation 1375. When the UEInformationRequest message includes an indicator requesting a RACH report, the terminal may identify whether a RPLMN is currently included in plmnIdentityList of a VarRACH-report at operation 1380. When the RPLMN is not included in the plmnIdentityList of the VarRACH-report, the terminal may include the content of the current VarRACH-Report of the RACH-Report list in a UEInformationResponse message at operation 1385, and transmit the same to the base station at operation 1390. Operation 1380 may be replaced with operations 1115 and 1120 in FIG. 11, operations 1215 and 1220 in FIG. 12, or other embodiments described above. When the terminal has successfully transmitted the RACH report to the base station, the terminal may discard the content of the VarRACH-Report, included in the transmission at operation 1395.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a wireless communication system, the method comprising:
performing a random access procedure with a base station;
clearing first information associated with a public land mobile network (PLMN) and second information associated with the random access, in case that the first information does not include PLMN information associated with a registered PLMN in the terminal; and
storing report information associated with the random access.

2. The method of claim 1, the further comprising:
setting the first information to third information associated with an equivalent PLMN.

3. The method of claim 1, the further comprising:
storing the report information associated with the random access, in case that the first information includes the PLMN information associated with the registered PLMN in the terminal.

4. The method of claim 1,
wherein the report information associated with the random access includes information on a cell identity, information on a purpose of the random access, and information on a PLMN identity.

5. The method of claim 1, the further comprising:
receiving, from the base station, a request message associated with terminal information; and
transmitting, to the base station, a response message as a response to the request message,
wherein the response message includes the report information.

6. The method of claim 4,
wherein the information on the purpose of the random access includes information for first random access, information on beam failure recovery, information for accessing a target cell during handover, and information on uplink un-synchronization.

7. The method of claim 4,
wherein the information on the cell identity is associated with a cell global identity (CGI).

8. A terminal in a wireless communication system, the terminal comprising:
a transceiver; and
at least one processor configured to:
perform a random access procedure with a base station,
clear first information associated with a public land mobile network (PLMN) and second information associated with the random access, in case that the first information does not include PLMN information associated with a registered PLMN in the terminal, and
store report information associated with the random access.

9. The terminal of claim 8, the at least one processor configured to:
set the first information to third information associated with an equivalent PLMN.

10. The terminal of claim 8, the at least one processor configured to:
store the report information associated with the random access, in case that the first information includes the PLMN information associated with the registered PLMN in the terminal.

11. The terminal of claim 8,
wherein the report information associated with the random access includes information on a cell identity, information on a purpose of the random access, and information on a PLMN identity.

12. The terminal of claim 8, the at least one processor configured to:
receive, from the base station via the transceiver, a request message associated with terminal information, and
transmit, to the base station via the transceiver, a response message as a response to the request message,
wherein the response message includes the report information.

13. The terminal of claim 11,
wherein the information on the purpose of the random access includes information for first random access, information on beam failure recovery, information for accessing a target cell during handover, and information on uplink un-synchronization.

14. The terminal of claim 11,
wherein the information on the cell identity is associated with a cell global identity (CGI).

15. The method of claim 1, the further comprising:
discarding a random access channel (RACH) report generated according to each random access trial from the second information, in case that a predetermined time passes.

16. The terminal of claim 8, the at least one processor configured to:
discard a random access channel (RACH) report generated according to each random access trial from the second information, in case that a predetermined time passes.

17. At least one non-transitory computer readable recording medium configured to store a program for executing a method for obtaining an image through an electronic device, the method comprising:
performing a random access procedure with a base station;
clearing first information associated with a public land mobile network (PLMN) and second information associated with the random access, in case that the first information does not include PLMN information associated with a registered PLMN in the terminal; and
storing report information associated with the random access.
